(19) United States
(12) Patent Application Publication
(10) Pub. No.: US 2022/0396505 A1
(43) Pub. Date: Dec. 15, 2022

(54) SYSTEM AND METHOD FOR PRODUCING ELECTROCHEMICALLY ACTIVATED SOLUTIONS

(71) Applicant: Annihilare Medical Systems, Inc., Lincolnton, NC (US)

(72) Inventors: Clay Parker Sipes, Conover, NC (US); Marion E. Paris, JR., Lincolnton, NC (US); Lynden Troy Berry, Lincolnton, NC (US); Samuel James Vandesande, Charlotte, NC (US)

(73) Assignee: Annihilare Medical Systems, Inc., Lincolnton, NC (US)

(21) Appl. No.: 17/344,951

(22) Filed: Jun. 11, 2021

(51) Int. Cl. C02F 1/461; C01D 1/04; C01B 11/04; C25B 1/16; C25B 1/26

(52) U.S. Cl. CPC C02F 1/4618; C01D 1/04; C01B 11/04; C25B 1/16; C25B 1/26; C02F 2201/4611; C02F 2201/46115; C02F 2303/04

(57) ABSTRACT

A system and associated method for producing an HOCl solution and an NaOH solution includes a generator operable for producing the HOCl and NaOH solutions utilizing electricity and a mixture of water and brine in an electrolysis cell. The generator includes a mechanical fixed flow restrictor (FFR) operable for controlling at least one of a pH of the HOCl solution and a free available chlorine (FAC) of the HOCl solution. The FFR includes an insert having a longitudinal fluid passageway. The length of the insert and the diameter of the fluid passageway are selected to control the pH of the HOCl solution and/or the FAC of the HOCl solution. The FFR is interchangeable so that the pH of the HOCl solution and/or the FAC of the HOCl solution can be precisely controlled.

### FIELD OF THE INVENTION

The present invention relates generally to an improved system and method for producing electrochemically activated (ECA) solutions. More particularly, the present invention relates to a system and method for producing cleaning, degreasing, sanitizing and disinfecting solutions utilizing the electrochemically activated water (EAW) process. In an advantageous embodiment, the present invention is a generator for producing hypochlorous acid (HOCl) solution and sodium hydroxide (NaOH) solution, and an associated method for controlling the pH of the HOCl solution and/or the free available chlorine (FAC) in the HOCl solution.

### BACKGROUND OF THE INVENTION

Many facilities, including hospitals, nursing homes, prisons, schools and public terminals, are highly susceptible to multi-drug resistant organisms (MDROs), commonly referred to as infectious bacteria and viruses. For example, the Centers for Disease Control and Prevention (CDCP) estimates that infections acquired from healthcare and food service facilities kill more individuals each year than vehicle accidents, breast cancer or AIDS. As a result, the Environmental Protection Agency (EPA) and the Food and Drug Administration (FDA) prescribe effective cleaning and disinfecting procedures to be used in facilities that provide healthcare services and/or food services. In response, hospitals, nursing homes, prisons and schools have instituted detailed cleaning and disinfecting protocols along with intensive training programs for environmental services personnel to ensure that areas accessed by patients, staff and the public are clean and hygienic.

The aforementioned facilities, especially healthcare facilities, have historically utilized a variety of high, medium and low level disinfectants, including formaldehyde, hydrogen peroxide, peracetic acid and chlorine-releasing agents (CRAs), including sodium hypochlorite, iodophor and phenol solutions. More recently, solutions of hypochlorous acid (HOCl) have been introduced as an efficacious and environmentally friendly alternative to traditional disinfectants. HOCl is a weak acid formed when chlorine dissolves in water and partially dissociates. Consequently, HOCl acts as an oxidizer and a primary disinfecting agent in a chlorine solution. The beneficial characteristics attributed to HOCl include that it is a highly effective disinfectant for destroying infectious bacteria and viruses, most notably C. diff, E-Coli, MRSA (Staph), Salmonella, Tuberculosis, Human Immunodeficiency Virus (HIV), and Severe Acute Respiratory Syndrome (SARS). Despite being highly effective, HOCl is relatively harmless to humans at concentrations sufficient for effective sanitizing and disinfecting. Consequently, HOCl solutions are approved for use as sanitizers and disinfectants in hospitals, nursing homes, prisons, schools and public terminals.

Other cleaning and disinfectant agents commonly used in the aforementioned facilities are not as environmentally friendly or as effective as HOCl in destroying harmful and deadly bacteria and viruses. As a result, it is not uncommon for individuals to contract serious illnesses from the bacteria and viruses at those facilities that are treated with other disinfectants. The inability to effectively destroy infectious organisms increases healthcare costs and causes physical harm to individuals that could have been prevented with the use of the more effective HOCl sanitizing and disinfecting agent.

Although highly effective, HOCl has a limited lifespan of effectiveness as a disinfectant, referred to commercially as its “shelf life.” Over time HOCl decomposes to chloric acid, hydrochloric acid, and oxygen; none of which separately exhibits the same desirable disinfectant properties as a full strength HOCl solution. The shelf life for HOCl solution as a sanitizing and disinfecting agent is limited from the time it is produced based on its free available chlorine (FAC) concentration. As used herein, the term “free available chlorine (FAC)” is intended to mean the portion of total chlorine in the solution that is present as hypochlorous acid (HOCl) or hypochlorite ion (OCl—). Consequently, it is imperative to take steps to ensure that an effective HOCl disinfectant solution is being used by environmental services personnel in an established cleaning and disinfecting protocol at facilities such as hospitals, nursing homes, prisons, schools and public terminals. In particular, it is essential that environmental services personnel use an HOCl solution that is within the life cycle of effectiveness that is acceptable for its cleaning, sanitizing and/or disinfecting purpose.

Another critical component in the production of an effective HOCl solution is control of the hydrogen ion concentration, commonly referred to as pH, of the solution. In the production of HOCl solution utilizing the EAW process, the co-product NaOH essentially dictates the pH of the HOCl solution because NaOH has a naturally higher pH. Consequently, the more NaOH present in the EAW process the higher the pH of the HOCl, and conversely, the less NaOH present in the EAW process the lower the pH of the HOCl. Existing systems for producing HOCl and NaOH solutions, referred to herein as generators, utilize a flow restricting valve in the form of a needle valve to increase or decrease backpressure on the NaOH output as a means for controlling the pH of the HOCl solution. The backpressure causes a portion of the NaOH solution in the NaOH output line to re-circulate back through the generator instead of into the NaOH receptacle. As a result, the additional NaOH solution in the generator raises the pH of the HOCl solution. As such, the pH of the HOCl solution can be adjusted upwards or downwards using the needle valve to increase or decrease the backpressure on the NaOH output and thereby increase or decrease, respectively, the NaOH solution re-circulated through the generator.

The needle valve allows a technician to balance the flow of the NaOH solution between the generator and the NaOH output receptacle, and in so doing, calibrate the pH of the HOCl solution to a desired pH between about 5.5 and about 7.5, and more particularly between about 6.0 and about 7.0. However, the needle valve also has the negative effect of introducing the opportunity for inexperienced or inattentive technicians to tamper with the needle valve setting, thereby causing an inconsistent pH of the HOCl solution. Furthermore, the needle valve adversely increases the cost, complexity and maintenance of a generator for producing HOCl and NaOH solutions. Thus, it would be advantageous to eliminate the needle valve from the conventional generator, while maintaining a means for precisely controlling the pH of the HOCl solution and/or the FAC in the HOCl solution.

In view of the foregoing, it is apparent a need exists for an improved system and method for producing ECA solutions. A more particular need exists for a system and method for producing cleaning, degreasing, disinfecting and sanitizing solutions utilizing an EAW process. Furthermore, a specific need exists for a generator for producing HOCl and NaOH solutions, and a method for controlling the pH of the HOCl solution and/or the FAC in the HOCl solution. Such a system and method would necessarily produce environmentally safe and effective NaOH cleaning and degreasing solutions, as well as environmentally safe and highly effective HOCl sanitizing and disinfecting solutions in compliance with EPA and FDA requirements.

Certain aspects, objects, features and advantages of the invention will be made apparent, or will be readily understood and appreciated by those skilled in the relevant art, with reference to the exemplary embodiments of the invention described herein and shown in the accompanying drawing figures. It is intended that the certain aspects, objects, features and advantages of the invention set forth herein be construed in accordance with the ordinary and customary meaning of the elements, terms and limitations of the appended claims given their broadest reasonable interpretation consistent with this written disclosure and accompanying drawing figures. Some or all aspects, objects, features and advantages of the invention, as well as others not expressly or inherently disclosed herein, may be accomplished by one or more of the exemplary embodiments described herein and shown in the accompanying drawing figures. However, it should be appreciated that the written description and drawing figures are for illustrative purposes only, and that many modifications, substitutions or revisions may be made to the exemplary embodiments without departing from the general concepts of the invention and the intended broad scope and proper construction of the appended claims.

### BRIEF DESCRIPTION OF THE DRAWINGS

The aforementioned aspects, objects, features and advantages of the invention will be more fully understood and appreciated when considered with reference to the accompanying drawing figures, in which like reference characters designate the same or similar parts throughout the several views.

FIG. 1 is a front perspective view of an exemplary embodiment of an improved system and associated method for producing NaOH and HOCl solutions according to the present invention.

FIG. 2 is a side perspective view of the system of FIG. 1.

FIG. 3 is a front perspective view of an exemplary embodiment of a generator of the system of FIG. 1 shown with the front cover in an opened position for purposes of clarity.

FIG. 4 is a side perspective view of the generator of FIG. 3.

FIG. 5 is an elevation view of an exemplary embodiment of an electrolysis cell of the generator of FIG. 3.

FIG. 6 is an exploded view of the components of the electrolysis cell of FIG. 5.

FIG. 7 is a plan view of the anode of the electrolysis cell of FIG. 5.

FIG. 8 is a cross-sectional view of the electrolysis cell of FIG. 5 taken along the line 8-8 indicated by FIG. 5.

FIG. 9 is a cross-sectional view of the anode of FIG. 7 taken along the line 9-9 indicated by FIG. 7.

FIG. 10 is an end view of the electrolysis cell of FIG. 5.

FIG. 11 is an enlarged perspective view of an exemplary embodiment of a fixed flow restrictor (FFR) of the generator of FIG. 3.

FIG. 12 is an enlarged cross-sectional view of the FFR of FIG. 11 taken along the line 12-12 indicated by FIG. 11.

### DETAILED DESCRIPTION OF EXEMPLARY EMBODIMENTS OF THE INVENTION

Exemplary embodiments of the present invention are described in greater detail and shown in the accompanying drawing figures. The embodiments described and shown herein are directed to an improved system and method for producing ECA solutions. More particularly, the present invention is an improved system and method for producing cleaning, degreasing, sanitizing and disinfecting solutions utilizing the EAW process. ECA is a technology that produces the non-synthetic and biodegradable biocide compound hypochlorous acid (HOCl) solution and the cleaning agent sodium hydroxide (NaOH) solution. An ECA solutions generator produces HOCl solution and NaOH solution from water, salt and electricity utilizing an electrolysis cell. In an advantageous embodiment, the present invention is a generator for producing HOCl and NaOH solutions, and an associated method for controlling the pH of the HOCl solution and/or the FAC in the HOCl solution. Various aspects, objects, features and advantages of the present invention are illustrated by exemplary embodiments of an improved system and an associated method for producing HOCl and NaOH solutions. In a particularly advantageous embodiment, the system and method includes a generator operable for controlling the pH of the HOCl solution and/or the FAC in the HOCl solution, as will be described in greater detail hereafter.

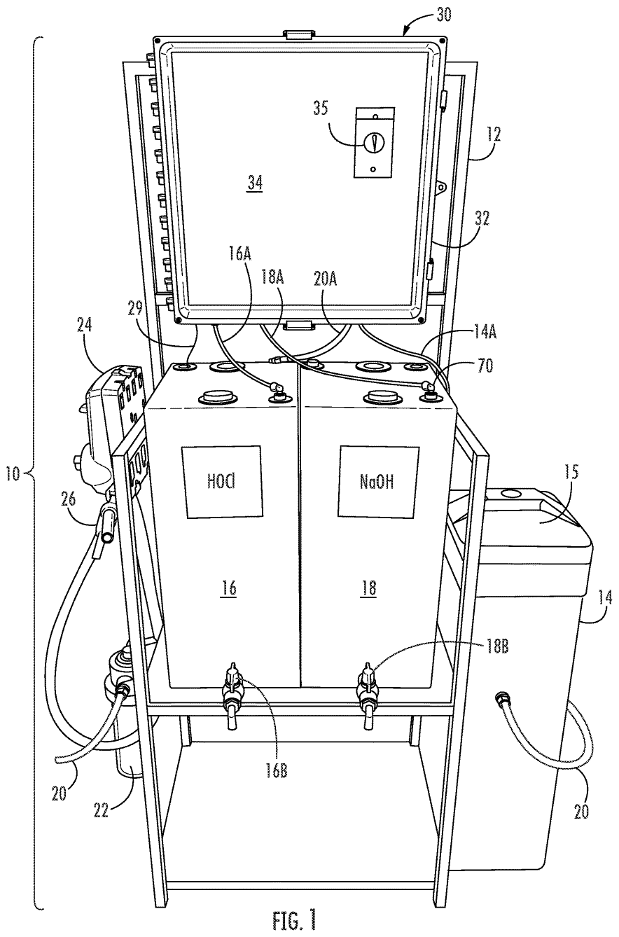

FIG. 1 is a front perspective view showing an exemplary embodiment of an improved system 10 and associated method for producing HOCl solution and NaOH solution according to the present invention. System 10 includes an optional stand, rack or the like 12 configured for supporting components of the system 10. As shown herein, system 10 comprises a brine tank 14 that is in fluid (flow) communication with an ECA solutions generator 30 that may be securely mounted onto the stand 12, or alternatively, may be wall-mounted. The brine tank 14 defines an interior compartment (not shown) configured to receive salt, such as high purity sodium chloride (NaCl) or potassium chloride (KCl), and an external source of fresh water to form a suitable saltwater solution, commonly referred to as brine. Brine tank 14 is in fluid (flow) communication with the generator 30 by means of a brine input conduit 14A. The brine tank 14 is preferably formed from a relatively lightweight, yet durable, chemically resistant and anti-corrosive plastic material, and the brine conduit 14A is preferably formed from a chemically resistant and anti-corrosive plastic material, for example polyvinylchloride (PVC) tubing that may be reinforced with spiral wound polyester yarn for increased strength and durability. Brine tank 14 may have a removable cover 15 providing access to the interior compartment for the purpose of filling the brine tank 14 with the salt and fresh water. The salt for the brine tank 14 is typically provided in the form of one or more salt blocks or salt pellets in a known manner. As shown herein, brine tank 14 is provided with a fill conduit 20 and an optional drain line (not shown) for regulating the amount of fresh water within the interior compartment of the brine tank 14.

System 10 further comprises a first receptacle 16 that is likewise in fluid (flow) communication with the generator 30, and a second receptacle 18 that is also in fluid (flow) communication with the generator 30. First receptacle 16 is configured to receive and retain HOCl solution produced by the generator 30 through HOCl output conduit 16A. Similarly, second receptacle 18 is configured to receive and retain NaOH solution produced by the generator 30 through NaOH output conduit 18A. The first receptacle, also referred to herein as HOCl tank 16, is provided with a gravity nozzle in the form of a first spigot 16B for dispensing the HOCl solution from the HOCl tank 16 into another container, such as a spray bottle (not shown). Likewise, the second receptacle, also referred to herein as NaOH tank 18, is provided with a gravity nozzle in the form of a second spigot 18B for dispensing the NaOH solution from the NaOH tank 18 into another container, such as a spray bottle (not shown).

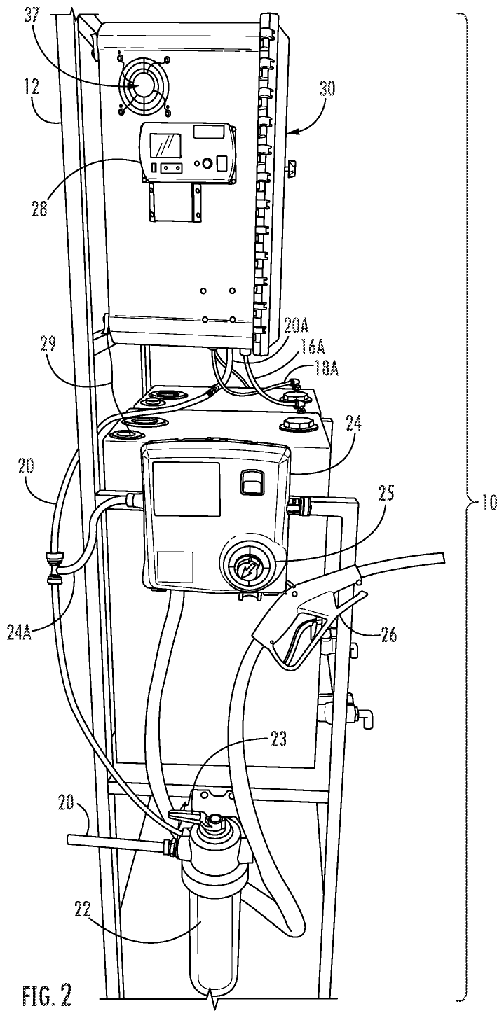

FIG. 2 is a side perspective view of the system 10 of FIG. 1. As best shown in FIG. 2, the fill conduit 20 is also configured to deliver the external source of fresh water to the generator 30 through a water input conduit 20A. Preferably, the external source of fresh water is pre-softened and a water filtration unit 22 is provided for filtration of the softened fresh water. Filtration unit 22 has a selector valve 23 for directing the flow of the softened and filtered fresh through fill conduit 20 to the brine tank 14, to the generator 30 through water input conduit 20A, or alternatively, to a dilution station 24 mounted on the stand 12 of system 10 through a dilution water input conduit 24A. Dilution station 24 is operable for producing additional ECA solutions having different strengths by diluting the HOCl solution or the NaOH solution with fresh water. Dilution station 24 is provided with a selector knob 25 for selecting a desired HOCl and fresh water diluted solution, or alternatively, a desired NaOH and fresh water diluted solution. By way of example and not limitation, the dilution station 24 is configured to produce various cleaning, degreasing, sanitizing and/or disinfecting solutions having different FAC concentrations. Regardless, the diluted HOCl solution or diluted NaOH solution selected from the dilution station 24 is dispensed to another receptacle, such as a transport container, spray cart, bottle or the like, through an output nozzle 26. System 10 further comprises a pH meter 28 operable for visually monitoring the pH of the HOCl solution in the HOCl tank 16 by means of a pH probe wire 29 that extends from within the HOCl tank 16 and into the generator 30 to pH meter 28. Preferably, the readable gauge of the pH meter 28 is located on the exterior of the generator 30 so that a technician can monitor the pH of the HOCl solution produced by the generator 30 without having to access the interior of the generator 30.

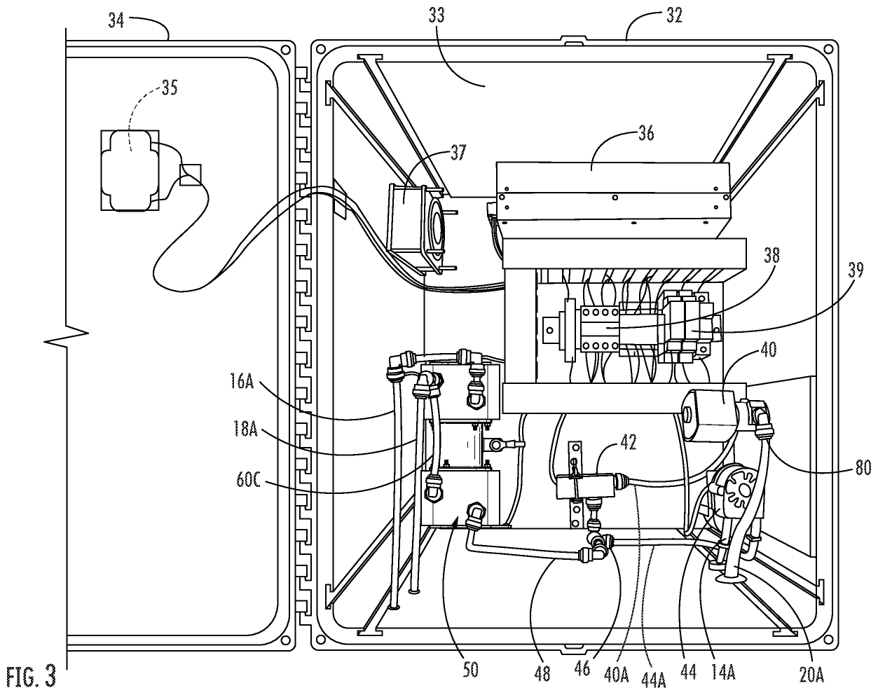

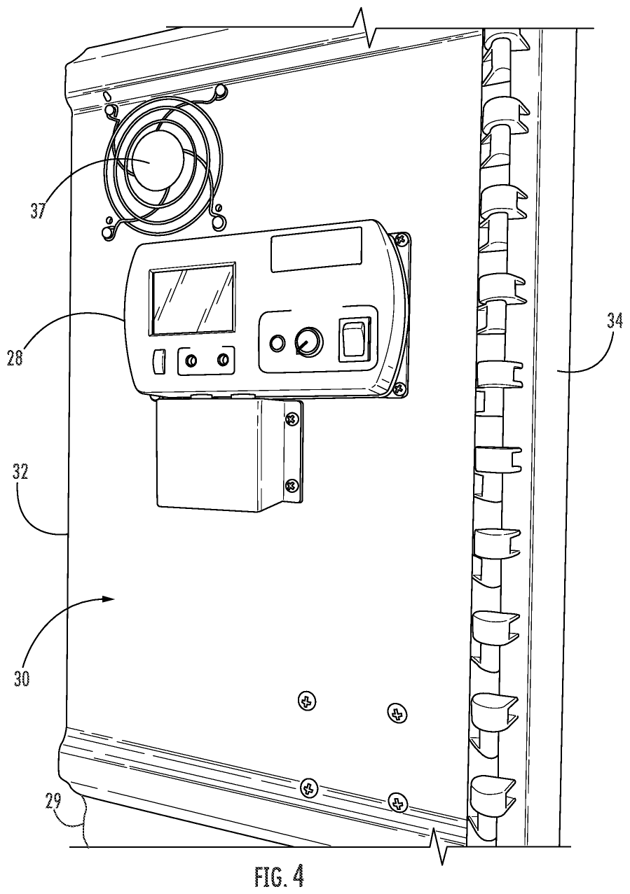

FIG. 3 is a front perspective view showing an exemplary embodiment of a generator 30 of the system 10. FIG. 4 is a side perspective view of the generator 30. Generator 30 comprises a generally cuboid, hollow housing 32 that defines an interior compartment 33 for housing components of the generator 30. Housing 32 is provided with a movable front cover 34 for providing access to the interior compartment 33. As shown herein, front cover 34 is in the form of an access panel, door or the like that is attached to the housing 32 by a hinge, such that the front cover 34 is movable between a closed position depicted in FIG. 1 and an opened position depicted in FIG. 3. The front cover 34 is shown in the opened position in FIG. 3 for purposes of clarity to view internal components of the generator 30. Generator 30 may include an electrical on-off switch or mechanical timer switch 35 on the front cover 34 of the housing 32 to allow a technician to operate the generator 30 for a predetermined period of time, for example a run-time of 30, 60 or 90 minutes, without the technician having to access the components disposed within the interior compartment 33 of the housing 32. If desired, the housing 32 may also be provided with a means for securely locking the front cover 34 on the housing 32 to restrict access to the interior compartment 33 of the housing 32 to authorized personnel as a precaution against inadvertent or malicious tampering with the electrical and mechanical components of the generator 30.

As shown in FIG. 3, generator 30 further comprises a DC power supply 36 for supplying electrical power to electrical components of the generator 30. Power supply 36 is preferable cooled by a fan 37 disposed on an interior side wall of the generator 30 adjacent the power supply 36. A contactor 38 electrically coupled to the power supply 36 is provided for controlling electrical power flow to the electrical components of the generator 30 in a timed manner. For example, the contactor 38 may supply 12/24 VDC power to an electrolysis cell 50 (to be described hereafter) and 120/240 VAC power to pumps, solenoids, timers, etc. Consequently, contactor 38 may comprise a fuse box, a 12 VAC to 12 VDC transformer, terminal blocks for routing wiring and/or a timer relay 39. As best shown in FIG. 3, water input conduit 20A delivers the pre-softened, filtered water from the external source of fresh water to the generator 30. The water input conduit 20A is connected to a solenoid valve 40 and further through conduit 40A to a flow sensor switch 42 that controls the on/off flow of fresh water to the generator 30. Flow sensor switch 42 in conjunction with timer relay 39 prevents production of chlorine (CI) gas for safety purposes, while ensuring the quality of the HOCl solution, by shutting down operation of the generator 30 in the event of an insufficient water supply. Flow sensor switch 42 is operable for regulating the amount of pre-softened, filtered water delivered to the generator 30 via the water input conduit 20A that is mixed with brine delivered to the generator 30 from the brine tank 14 via brine input conduit 14A. Generator 30 further comprises a brine pump 44 for pumping the brine delivered to the generator 30 via brine input conduit 14A through conduit 44A to a tee-fitting 46 where the 100% fresh water and the 100% brine are combined together to form a diluted mixture of fresh water and brine in water/brine input conduit 48. In an advantageous embodiment, brine pump 44 is a positive displacement pump, and preferably, is an electromechanical peristaltic pump operable for pumping the brine at a predetermined constant flow rate, wherein the DC motor and tubing size selection of the peristaltic pump 44 determines the flow rate of the brine.

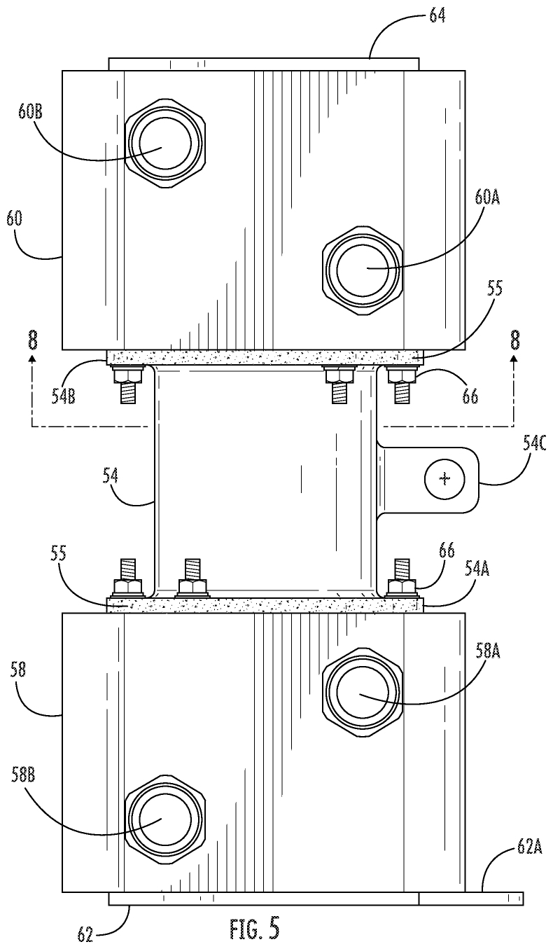

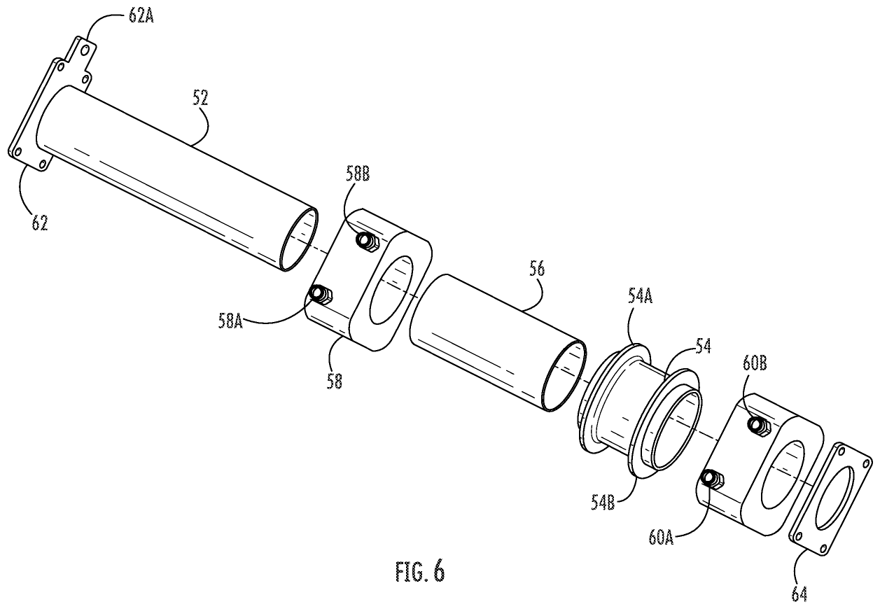

Electrolysis cell 50 of generator 30 is configured to receive the mixture of fresh water and brine via the water/brine input conduit 48. FIG. 5 is an elevation view of an exemplary embodiment of an electrolysis cell 50 of the generator 30. FIGS. 6-10 show components of the electrolysis cell 50 in greater detail. Electrolysis cell 50 utilizes the diluted mixture of fresh water and brine and electricity provided by the system 10 to produce ECA solutions utilizing the EAW process in a manner that is well known to those having ordinary skill in the art. Specifically, the electrolysis cell 50 of generator 30 produces an HOCl solution that is delivered to the HOCl tank 16 through the HOCl output conduit 16A and an NaOH solution that is delivered to the NaOH tank 18 through the NaOH output conduit 18A. As previously mentioned, the HOCl solution in the HOCl tank 16 and the NaOH solution in the NaOH tank 18 may be diluted thereafter by the dilution station 24 to produce additional cleaning, degreasing, sanitizing and disinfecting solutions having various concentrations of FAC measured in parts-per-million (PPM).

As best shown in FIG. 5 and FIG. 6, electrolysis cell 50 comprises a generally cylindrical cathode 52 and a generally cylindrical anode 54 separated by a generally cylindrical ion exchange membrane 56 that is disposed concentrically between cathode 52 and anode 54. Electrolysis cell 50 further comprises an annular input chamber 58 and an annular output chamber 60 disposed adjacent opposed ends of the anode 54. The input chamber 58 is configured for receiving the mixture of fresh water and brine from the water/brine input conduit 48 of the generator 30. Output chamber 60 is configured for delivering the HOCl solution to the HOCl output conduit 16A and for delivering the NaOH solution to the NaOH output conduit 18A, as will be described hereafter. The electrolysis cell 50 further comprises an input end cap 62 made of an electrically conductive material that is in electrical contact with the cathode 52 and an output end cap 64 made of an electrically conductive material that likewise is in electrical contact with the cathode 52. For ease of assembly, the input end cap 62 may be integrally formed with the cathode 52 as shown in FIG. 6 and mechanically attached to the input chamber 58, while the output end cap 64 is separate and mechanically attached to the output chamber 60.

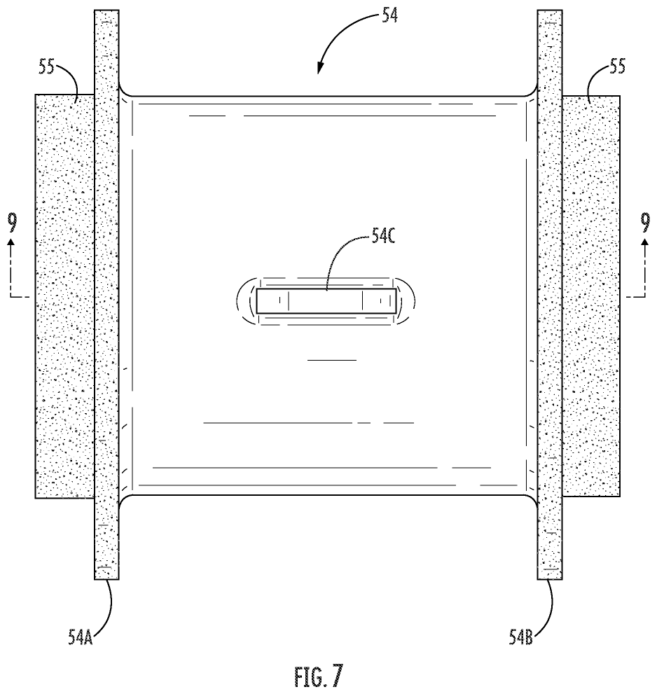

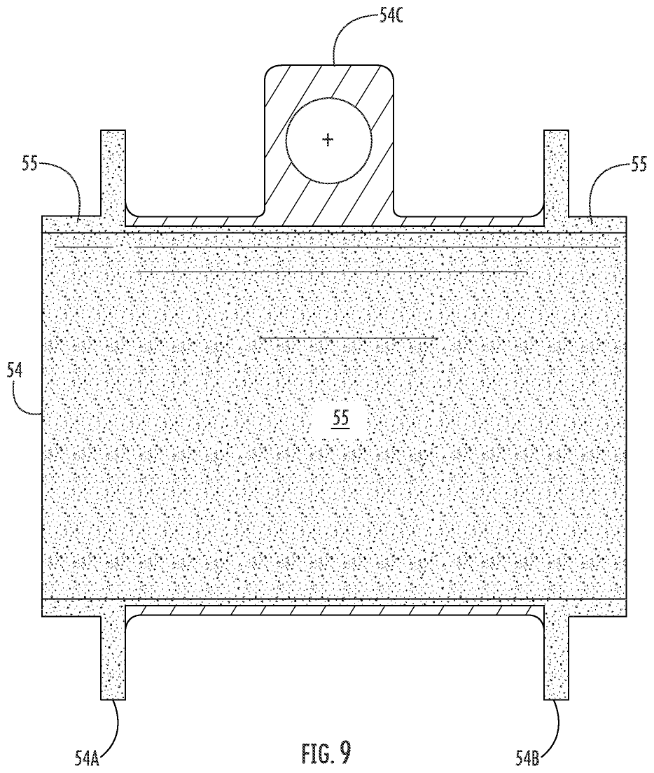

Cathode 52 is formed from a material that is at least a relatively good conductor of electricity. In an advantageous embodiment, cathode 52 (and consequently input end cap 62) is made of a stainless steel material, such as SS 316. Anode 54 likewise is formed of a material that is at least a relatively good conductor of electricity. In an advantageous embodiment, anode 54 is made of a titanium material, such as Ti 6Al-4V. Preferably, the titanium metal of anode 54 is provided with a coating 55 that inhibits the rapid corrosion caused by the highly corrosive environment within the electrolysis cell 50 of the generator 30 in the EAW process. As depicted by FIG. 7 and FIG. 9, the coating 55 may be applied only to the opposed ends of the anode 54 and to the interior surface of the anode 54 exposed to the EAW process within the electrolysis cell 50. The exterior surface of the anode 54 may remain uncoated as shown herein for reduction of cost and weight. Preferably, the coating 55 is formed from at least one transition metal. More preferably, the coating 55 is formed from a mixture of platinum group metals. By way of example and not limitation, in an advantageous embodiment the coating 55 is formed from at least one, and preferably, a mixture of ruthenium, rhodium, palladium, iridium and platinum metals.

The membrane 56 disposed between the radially inner cathode 52 and the radially outer anode 54 is formed from a material that has at least a relatively high porosity and has at least a relatively high hardness with sufficient tensile and compressive strength. In an advantageous embodiment, membrane 56 is preferably made of a ceramic material, such as aluminum oxide (Al₂O₃) or silicon dioxide (SiO₂). The input chamber 58 and the output chamber 60 are each formed from a material that is at least relatively resistant to corrosion and that has at least a relatively high hardness. Preferably, input chamber 58 and output chamber 60 are each made of a hard plastic material, such as a thermoplastic polymer. By way of example and not limitation, in an advantageous embodiment the input chamber 58 and the output chamber 60 are each made of a high-density polyethylene (HDPE) material, also known as polyethylene high-density (PEHD) material. If desired, input conduit 48, HOCl output conduit 16A and NaOH output conduit 18A may be made of the same HDPE or PEHD material for purposes of material compatibility and cost reduction.

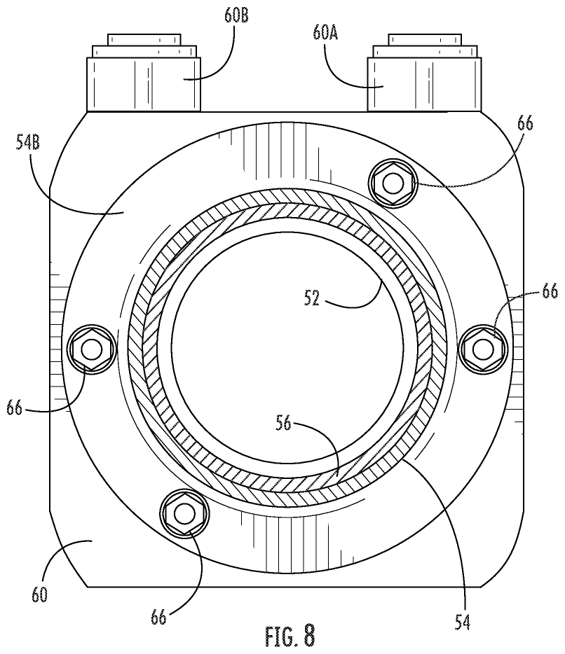

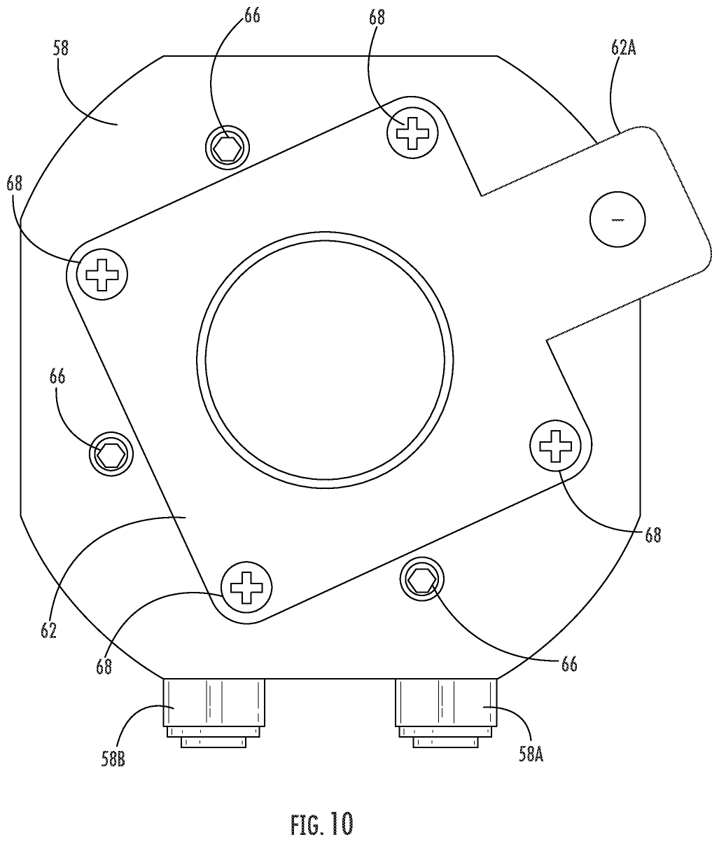

As best depicted by FIG. 5 and FIG. 6, input chamber 58 is positioned over the free end of cylindrical cathode 52. The cylindrical membrane 56 is next positioned over the cathode 56 such that the membrane 56 extends beyond the input chamber 58. Cylindrical anode 54 is next positioned over the cylindrical membrane 56 such that membrane 56 is disposed radially between the cathode 52 and the anode 54. Anode 54 is attached through a first flange 54A to the input chamber 58 by, for example a plurality of fasteners 66, while input chamber 58 is attached to input end cap 62, for example, by a plurality of fasteners 68, as shown in FIG. 10. The output chamber 60 is next positioned over the free end of the cathode 52 and attached to the anode 54 through a second flange 54B of anode 54 by, for example a plurality of fasteners 66, as shown in FIG. 8. Finally, the output end cap 64 is positioned over the output chamber 60 and attached thereto, for example by a plurality of fasteners 68, in the same manner as input end cap 62 is attached to input chamber 58.

Input chamber 58 is provided with a first input port 58A configured for introducing the mixture of fresh water and brine delivered to the electrolysis cell 50 through the water/brine input conduit 48. Input chamber 58 is also provided with a second input port 58B for a purpose to be described hereafter. As the mixture of fresh water and brine passes through the electrolysis cell 50, electricity is applied to an electrically conductive tab 54C provided on the anode 54 that serves as a positive terminal for the electrolysis cell 50. Another electrically conductive tab 62A provided on the input end cap 62 serves as a negative (neutral or ground) terminal for the electrolysis cell 50. Cathode 52 and anode 54 separate the electrically charged ions of the mixture of fresh water and brine across the porous membrane 56 into an NaOH solution at the cathode 52 and an HOCl solution at the anode 54 in a manner well known to those skilled in the art. As a result, the HOCl solution is available at an output port 60A provided on the output chamber 60 and the NaOH solution is available at an output port 60B likewise provided on the output chamber 60.

As previously mentioned, the pH of the HOCl solution is essentially dictated by the pH of the NaOH solution because NaOH has a naturally higher pH. Consequently, the introduction of additional NaOH into the EAW process results in a responsive increase in the pH of the HOCl solution. Conventional generators for producing HOCl solution and NaOH solution utilize a needle valve to create backpressure in the output line of the NaOH solution to introduce additional NaOH into the EAW process. However, a needle valve adds cost and complexity to the manufacture of the generator, while reducing the reliability and accuracy of the generator due to the opportunity for technician error and/or tampering. In addition, the inner walls of the needle valve also create flow turbulence that results in an inconsistent pH of the HOCl solution. The present invention eliminates the needle valve and other components of a conventional generator to thereby provide a more economical, less complex and more reliable system and method for producing ECA solutions. By way of example and not limitation, the improved system 10 and associated method of the present invention eliminates the need for internal pH monitoring, needle valve calibration and flow meter components of the generator 30.

As best shown in FIG. 3, the output port 60A of the output chamber 60 is in fluid communication through a fluid coupling and fittings with the HOCl output conduit 16A leading to the HOCl tank 16. Similarly, the output port 60B of the output chamber 60 is in fluid communication through a fluid coupling and fittings with the NaOH output conduit 18A leading to the NaOH tank 18. However, according to the present invention, a purely mechanical fixed flow restrictor (FFR) is positioned within the NaOH output conduit 18A. The FFR in the NaOH output conduit 18A operates to create a backpressure and thereby divert NaOH solution back to the electrolysis cell 50 through an NaOH return conduit 60C that leads to the input port 58B provided on the input chamber 58. In this manner, additional NaOH passes through the electrolysis cell 50 that acts to increase the pH of the HOCl solution due to the higher pH of the NaOH.

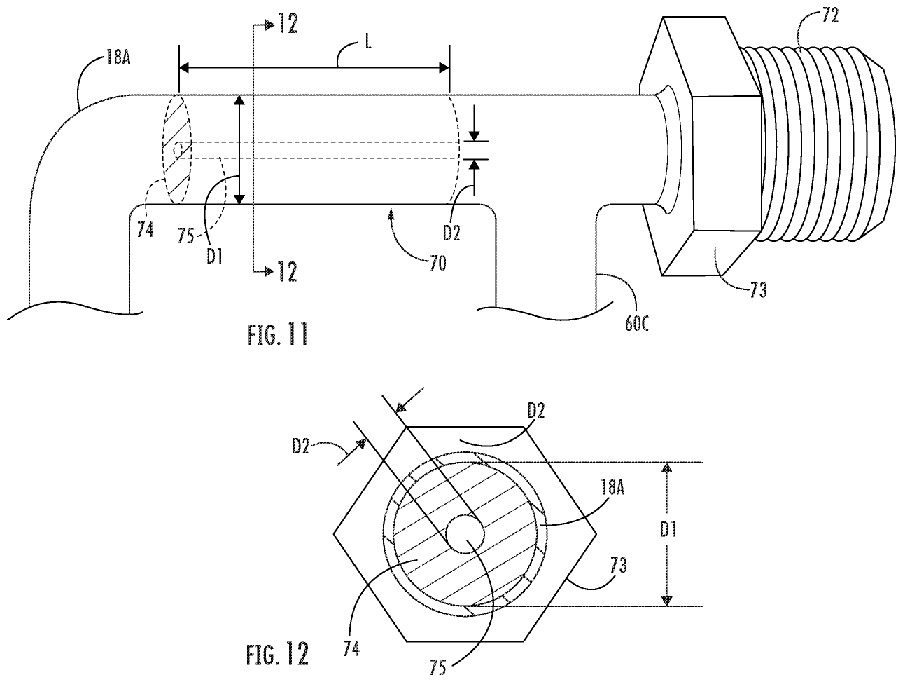

FIG. 11 is an enlarged perspective view of an exemplary embodiment of a FFR 70 for the generator 30 of the system 10 of the present invention. FIG. 12 is an enlarged cross-sectional view of the FFR 70 shown in FIG. 11. A fluid coupling comprises a threaded portion 72 and a hex head 73 for engaging the NaOH output conduit 18A and the NaOH return conduit 60C in fluid communication with the output port 60B of the output chamber 60. The FFR 70 comprises a generally cylindrical insert 74 formed from a material that is at least relatively resistant to corrosion and has at least a relatively high hardness. Preferably, the insert 74 is made of a hard plastic material, such as a thermoplastic polymer. By way of example and not limitation, in an advantageous embodiment the insert 74 is made of an HDPE or PEHD material. A fluid passageway 75 in the form of a longitudinally extending bore is provided through the insert 74. In the illustrated embodiment, fluid passageway 75 is located concentrically within the insert 74. Regardless, the insert 74 has an outer diameter indicated by D1 that corresponds closely to the inner diameter of the NaOH output conduit 18A. As a result, insert 74 has a relative interference (friction) fit within the NaOH output conduit 18A that results in a fluid-tight connection between the insert 74 and the NaOH output conduit 18A. The insert 74 has a predetermined inner diameter (the diameter of fluid passageway 75) indicated by D2 and a predetermined length indicated by L that are dimensioned to create a backpressure that re-circulates a desired amount of the NaOH solution back through the electrolysis cell 50 via the return conduit 60C and input port 58B of input chamber 58. The desired amount of NaOH solution re-circulated through the electrolysis cell 50 produces a desired pH of the HOCl solution.

It should be noted that in an advantageous embodiment, the FFR 70 is interchangeable so that the pH of the HOCl solution delivered to the HOCl tank 16 via HOCl output conduit 16A can be precisely controlled. As will be readily apparent to those skilled in the art, varying the diameter D2 of the fluid passageway 75 (the inner diameter of insert 74) and the length L of the insert 74 changes the backpressure created in the NaOH output conduit 18A and thereby the amount of the NaOH solution that is diverted through return conduit 60C and re-circulated through the electrolysis cell 50 in a calculable manner. Consequently, the dimensions D2 and L of the insert 74 can be selected to produce a desired hydrogen ion concentration to control the pH of the HOCl solution. Accordingly, the present invention provides an associated method of controlling the pH of an HOCl solution produced utilizing the EAW process by selecting the diameter D2 of the fluid passageway 75 and the length L of the insert 74 of the FFR 70 for the electrolysis cell 50 of the generator 30.

In an advantageous embodiment, the inner diameter D2 of the insert 74 is selected from the range of about 0.02 to about 0.08 inches, preferably from about 0.02 to about 0.07 inches, and most preferably from about 0.055 to about 0.0625 inches, wherein the outer diameter D1 of the insert 74 is about 0.25 inches. In general, the length L of the insert 74 is less for a smaller diameter D2 of the fluid passageway 75 and the length L of the insert 74 is greater for a larger diameter D2 of the fluid passageway 75. The appropriate dimensions D2 and L to produce an ECA solution having a desired pH may be determined by a site survey of the water hardness and pH at a particular installation site. In addition, it should be noted that the FFR 70 may be located at any point within the NaOH output conduit 18A between the NaOH return conduit 60C and the NaOH tank 18. By way of example and not limitation, the FFR 70 alternatively may be positioned within the NaOH output conduit 18A adjacent the fluid coupling leading into the NaOH tank 18, as depicted in FIG. 1.

Furthermore, a FFR 80 configured in the same manner as FFR 70 described herein with reference to FIG. 11 and FIG. 12 may be provided for regulating the amount of pre-softened, filtered fresh water that is provided to the flow sensor switch 42 from the solenoid valve 40 through the conduit 40A. Thus, a FFR 80 may be positioned within the water input conduit 20A at any point between the fill conduit 20 and a fluid coupling and/or fitting at the solenoid valve 40, as depicted in FIG. 3, or alternatively, a fluid coupling and/or fitting at the flow sensor switch 42. The FFR 80 serves to control the amount (PPM) of FAC in the HOCl solution in a similar manner that will be readily apparent and understood by those having ordinary skill in the art. The FFR 80 is interchangeable so that the FAC of the HOCl solution delivered to the HOCl tank 16 via HOCl output conduit 16A can be precisely controlled.

As a result, the FFR 70 of the system 10 controls the pH of the HOCl solution and the FFR 80 of the system 10 controls the FAC in the HOCl solution produced by the generator 30 in the EAW process. Consequently, the FFR 70 and/or the FFR 80 reduce the complexity, cost and maintenance of the system 10, while increasing the flexibility and reliability of the system 10 since the purely mechanical FFR utilizes no moving parts and no electrical or computer controlled components.

The foregoing detailed description of exemplary embodiments of the system and associated method is merely illustrative of the general concepts and principles of the present invention. Regardless of the foregoing detailed description and illustrated embodiments, various other configurations of the system and other steps of the associated method, as well as reasonable equivalents thereof, will be readily apparent and understood by those having ordinary skill in the art. Accordingly, equivalents to those shown in the accompanying drawing figures and described in the written description are intended to be encompassed by the broadest reasonable interpretation and construction of the appended claims. Furthermore, as numerous modifications and changes to the exemplary embodiments will readily occur to those skilled in the art, the present invention is not to be limited to the specific configuration, construction, materials, manner of use and operation shown and described herein. Instead, all reasonably predictable and suitable equivalents and obvious modifications to the invention should be determined to fall within the scope of the appended claims given their broadest reasonable interpretation and construction in view of the accompanying written description and drawing figures in view of the combined teachings of the disclosures of the relevant prior art.

That which is claimed is:

1. A system for producing at least one electrochemically activated (ECA) solution, comprising:
a source of water;
a source of brine;
a source of electricity;
a generator operable for producing the ECA solution utilizing the electricity and a mixture of the water and the brine; and
a mechanical fixed flow restrictor (FFR) operable for controlling at least one of a pH of the ECA solution and a free available chlorine (FAC) of the ECA solution.

2. The system according to claim 1, wherein the ECA solution is hypochlorous acid.

3. The system according to claim 1, wherein the generator comprises an electrolysis cell and wherein the at least one ECA solution comprises a sodium hydroxide (NaOH) solution and a hypochlorous acid (HOCl) solution.

4. The system according to claim 1, wherein the FFR comprises an insert having a longitudinal fluid passageway formed therethrough, and wherein a length of the insert and a diameter of the fluid passageway are selected to control at least one of the pH of the ECA solution and the FAC of the ECA solution.

5. The system according to claim 4, wherein the diameter of the fluid passageway is selected to be between about 0.02 and about 0.08 inches.

6. The system according to claim 5, wherein the diameter of the fluid passageway is selected to be between about 0.02 and about 0.07 inches.

7. The system according to claim 4, wherein the diameter of the fluid passageway is selected to be between about 0.055 and about 0.0625 inches.

8. The system according to claim 1, wherein the at least one ECA solution comprises a first ECA solution and a second ECA solution, wherein the generator comprises a first output conduit for delivering the first ECA solution to a first receptacle and a second output conduit for delivering the second ECA solution to a second receptacle, and wherein the FFR is positioned within the second output conduit to control the pH of the ECA solution delivered to the second receptacle.

9. The system according to claim 8, wherein the first ECA solution is a sodium hydroxide (NaOH) solution and the second ECA solution is a hypochlorous acid (HOCl) solution, and wherein the FFR re-circulates a portion of the NaOH solution to produce a desired pH of the HOCl solution.

10. The system according to claim 9, wherein the pH of the HOCl solution is increased by re-circulating the NaOH solution.

11. The system according to claim 1, wherein the FFR regulates the amount of the water in the mixture of the water and the brine to control the FAC in the ECA solution.

12. A generator for producing a sodium hydroxide (NaOH) solution and a hypochlorous acid (HOCl) solution utilizing a source of water, a source of brine and a source of electricity in an electrochemically activated water (EAW) process, the generator comprising:
an electrolysis cell configured for inputting a mixture of the water and the brine and for outputting the NaOH solution and the HOCl solution; and
a mechanical fixed flow restrictor (FFR) comprising an insert having a fluid passageway configured for controlling at least one of a pH of the HOCl solution and a free available chlorine (FAC) of the HOCl solution.

13. The generator according to claim 12, further comprising an NaOH output conduit for receiving the NaOH solution output from the electrolysis cell, and wherein the FFR is positioned within the NaOH conduit.

14. The generator according to claim 13, wherein the insert of the FFR defines a length and the fluid passageway of the insert defines a diameter, and wherein the length of the insert and the diameter of the fluid passageway are selected to produce a desired pH of the HOCl solution.

15. The generator according to claim 12, further comprising a water input conduit for providing the water to the generator, and wherein the FFR is positioned within the water input conduit.

16. The generator according to claim 15, wherein the insert of the FFR defines a length and the fluid passageway of the insert defines a diameter, and wherein the length of the insert and the diameter of the fluid passageway are selected to produce a desired FAC of the HOCl solution.

17. The generator according to claim 12, wherein the fluid passageway defines a diameter that is selected to be between about 0.02 and about 0.08 inches.

18. A method for producing a first electrochemically activated (ECA) solution and a second electrochemically activated (ECA) solution, comprising:
providing a source of water and a water input conduit;
providing a source of brine and a brine input conduit;
providing a source of electricity;
providing a generator operable for utilizing the electricity and a mixture of the water and the brine to produce the first ECA solution and the second ECA solution;
delivering the first ECA solution to a first receptacle through a first output conduit and delivering the second ECA solution to a second receptacle through a second output conduit; and
providing a mechanical fixed flow restrictor (FFR) operable for controlling at least one of a pH of the first ECA solution and a free available chlorine (FAC) of the first ECA solution.

19. The method according to claim 18, further comprising positioning the FFR within the second output conduit to control the pH of the first ECA solution.

20. The method according to claim 18, further comprising positioning the FFR within the water input conduit to control the FAC of the first ECA solution.
